(19) United States
(12) Patent Application Publication
(10) Pub. No.: US 2025/0250127 A1
(43) Pub. Date: Aug. 7, 2025

(54) PLATE WAREHOUSING DEVICE AND INBOUND AND OUTBOUND METHOD APPLIED THERETO

(71) Applicant: VEEGOO TECHNOLOGY CO., LTD., Foshan (CN)

(72) Inventors: Jianping QIU, Foshan (CN); Daliao CHEN, Foshan (CN); Jianqiang ZOU, Foshan (CN)

(21) Appl. No.: 19/060,851

(22) Filed: Feb. 24, 2025

Related U.S. Application Data
(63) Continuation of application No. PCT/CN2025/077971, filed on Feb. 19, 2025.

(30) Foreign Application Priority Data
Jan. 25, 2025 (CN) 202510120248.X

(51) Int. Cl. B65G 49/06; B65G 43/08; B65G 47/91

(52) U.S. Cl. CPC B65G 49/067; B65G 43/08; B65G 47/91; B65G 49/062; B65G 2201/022; B65G 2203/0216; B65G 2203/0258; B65G 2203/041

(57) ABSTRACT

A plate warehousing device, including a photographing mechanism, a plate transferring mechanism, a weighing mechanism, a receiving mechanism, a storage mechanism, discharging mechanism and a control processor. The receiving mechanism is configured to receive a target plate. The plate transferring mechanism is configured to transfer the target plate among the receiving mechanism, the storage mechanism, the weighing mechanism and the discharging mechanism. The storage mechanism is configured to store the target plate after being put into a warehouse. The weighing mechanism is configured to acquire a weight of the target plate. The photographing mechanism is configured to photograph a target surface of the target plate to obtain an image of the target surface. The discharging mechanism is configured to receive the target plate from the plate transferring mechanism. An inbound and outbound method applied to the plate warehousing device is also provided.

### CROSS-REFERENCE TO RELATED APPLICATIONS

This application is a continuation of International Patent Application No. PCT/CN2025/077971, filed on Feb. 19, 2025, which claims the benefit of priority from Chinese Patent Application No. 202510120248.X, filed on Jan. 25, 2025. The content of the aforementioned application, including any intervening amendments made thereto, is incorporated herein by reference in its entirety.

### TECHNICAL FIELD

This application relates to warehousing technology, and more particularly to a plate warehousing device and an inbound and outbound method applied thereto.

### BACKGROUND

Artificial stone plates need to be stored in warehouses after production. In order to facilitate subsequent deep processing of the artificial stone plates, it is needed to obtain size information of the artificial stone plates for registration during entering the warehouses, so that artificial stone plates with corresponding sizes can be quickly selected for processing when they are released from the warehouses.

At present, when artificial stone plates are put into storage, sizes of the artificial stone plates are generally measured by manual measurement with tapes. Then, the artificial stone plates produced by the production line are placed on the shelves by manually operating a forklift, and the measured dimensions are recorded on the corresponding shelves. When the artificial stone plates are released from the warehouses, the shelves with artificial stone plates of corresponding dimensions are manually found, and then the artificial stone plates are taken away from the shelves by manually operating a forklift and transported to the next workstation for subsequent deep processing. This operation method is time-consuming and labor-intensive, resulting in low production and processing efficiency of artificial stone plates.

### SUMMARY

An object of the disclosure is to provide a plate warehousing device and an inbound and outbound method applied thereto, so as to solve the problem that existing inbound and outbound operation modes of artificial stone plates is time-consuming and labor-intensive, resulting in low production and processing efficiency of artificial stone plates.

In order to achieve the above object, the following technical solutions are adopted.

In a first aspect, this application provides a plate warehousing device, comprising:
a photographing mechanism;
a plate transferring mechanism;
a weighing mechanism;
a receiving mechanism;
a storage mechanism;
a discharging mechanism; and
a control processor;
wherein the receiving mechanism is configured to receive a target plate after being produced by a production line;
the plate transferring mechanism is configured to transfer the target plate among the receiving mechanism, the storage mechanism, the weighing mechanism and the discharging mechanism;
the storage mechanism is configured to store the target plate after being put into a warehouse;
the weighing mechanism is provided with a plate-carrying surface; the plate-carrying surface is configured to carry the target plate; and the weighing mechanism is configured to acquire a weight of the target plate when the target plate is placed on the plate-carrying surface;
the photographing mechanism has a photographing end facing toward the plate-carrying surface; and the photographing mechanism is configured to photograph a target surface of the target plate when the target plate is placed on the weighing mechanism to obtain an image of the target surface;
the discharging mechanism is configured to receive the target plate from the plate transferring mechanism; and
the control processor is in communication connection with the photographing mechanism, the plate transferring mechanism and the weighing mechanism; and the control processor is configured to receive the weight of the target plate and the image of the target surface, and calculate size parameters of the target plate according to the weight of the target plate and the image of the target surface.

In some embodiments, the receiving mechanism is a fixed stacking rack; and the discharging mechanism is a rotary stacking rack.

In some embodiments, the plate transferring mechanism is a suction cup-type manipulator having a picking end; a visual recognition mechanism is mounted at the picking end; and the visual recognition mechanism is configured to identify whether a surface of the target plate sucked by the picking end is the target surface to ensure the target surface to be directly opposite to the photographing end.

In some embodiments, the storage mechanism comprises a plurality of shelves and a shelf moving track;
the plurality of shelves are movably arranged on the shelf moving track; and the shelf moving track is configured to guide a movement direction of the plurality of shelves;
along a guiding direction of the shelf moving track, a first end of each of the plurality of shelves is mounted with a positioning component, and a second end of each of the plurality of shelves is mounted with a locking component; and the locking component of one of adjacent two shelves among the plurality of shelves is hooked to the positioning component of the other of the adjacent two shelves; and
a movable lifting assembly is provided below the plurality of shelves, and is movable along the shelf moving track; the movable lifting assembly is configured to drive the locking component to rotate, such that the locking component is separated from a corresponding positioning component hooked thereto.

In some embodiments, the locking component comprises a main portion and a limiting portion extending from an end of the main portion;
the positioning component is mounted at a first lower end of a side wall of each of the plurality of shelves; and the locking component is mounted at a second lower end of the side wall of each of the plurality of shelves; and
the main portion is rotatably connected to each of the plurality of shelves; the limiting portion is configured to be folded relative to the end of the main portion; and a hooking portion is provided at a connection between the limiting portion and the main portion, and is hooked to the positioning component.

In some embodiments, the movable lifting assembly comprises a traveling trolley and a trolley track; the trolley track is arranged side by side with the shelf moving track; the traveling trolley is movably arranged on the trolley track; and the trolley track is configured to guide a movement direction of the traveling trolley; and
the traveling trolley is provided with an electric linear cylinder.

In some embodiments, the weighing mechanism comprises a base plate; a plurality of supporting legs are mounted at a bottom surface of the base plate, a weighing sensor is provided between each of the plurality of supporting legs and the base plate; a plurality of first supporting rods are provided at a top surface of the base plate; the plurality of first supporting rods are configured to be extended obliquely and upwardly to form the plate-carrying surface arranged obliquely; a side of each of the plurality of first supporting rods is provided with a supporting component; and the supporting component is configured to support a middle portion of the plurality of first supporting rods.

In some embodiments, the supporting component is composed of a plurality of second supporting rods and a bracket; first ends of the plurality of second supporting rods are respectively connected to the plurality of first supporting rods; second ends of the plurality of second supporting rods are connected to the bracket; and a bottom end of the bracket is fixedly mounted on the top surface of the base plate; and
the plurality of first supporting rods are arranged in parallel and at equal intervals, and the plurality of second supporting rods are arranged in parallel and at equal intervals.

In a second aspect, this application provides an inbound and outbound method applied to the above plate warehousing device, comprising:
(1) performing initialization settings through steps of:
(1.1) collecting pixel lengths and pixel widths of n surface images of a reference plate obtained by photographing the reference plate at n reference photographing distances respectively, acquiring a length ratio of a surface length of the reference plate to a pixel length of each of the n surface images of the reference plate, and acquiring a width ratio of a surface width of the reference plate to a pixel width of each of the n surface images of the reference plate, wherein n≥2; and
(1.2) correlating the n reference photographing distances with a corresponding length ratio and a corresponding width ratio;
(2) identifying the target plate during inbound through steps of:
(2.1) placing the target plate at the receiving mechanism;
(2.2) taking out, by the plate transferring mechanism, the target plate from the receiving mechanism followed by placing on the plate-carrying surface according to recognition information of a visual recognition mechanism, so that the target surface is directly opposite to the photographing end;
(2.3) acquiring the weight M of the target plate through the weighing mechanism;
(2.4) acquiring a mounting distance H₁ from the photographing mechanism to the plate-carrying surface; matching the mounting distance H₁ with the n reference photographing distances to determine a first reference photographing distance that is equal to the mounting distance H₁ among the n reference photographing distances; and acquiring a length ratio and a width ratio that are correlated with the first reference photographing distance, wherein the length ratio that is correlated with the first reference photographing distance is defined as R_{rough}, and the width ratio that is correlated with the first reference photographing distance is defined as R_{rough}′;
(2.5) acquiring the image of the target surface; acquiring a pixel width w₁ and a pixel length l₁ of the target surface according to the image of the target surface; calculating a rough width W₁ of the target plate according to the pixel width w₁ and the R_{rough}′; and calculating a rough length L₁ of the target plate according to the pixel length l₁ and the R_{rough};
(2.6) calculating a rough thickness D₁ of the target plate, expressed as:

$${D}_{1} = M / ( {W}_{1} \times {L}_{1} \times ρ ) ,$$

wherein ρ is a preset density;
(2.7) comparing the rough thickness D₁ with a plurality of preset reference thicknesses, and selecting a preset reference thickness that is closest to the rough thickness D₁ among the plurality of preset reference thicknesses as a final thickness D₂ of the target plate;
(2.8) calculating a photographing distance H₂ from the photographing mechanism to the target surface, expressed as:

$${H}_{2} = {H}_{1} - {D}_{2} ;$$

(2.9) matching the photographing distance H₂ with the n reference photographing distances to determine a second reference photographing distance that is equal to the photographing distance H₂ among the n reference photographing distances; acquiring a length ratio and a width ratio that are correlated with the second reference photographing distance, wherein the length ratio that is correlated with the second reference photographing distance is defined as R_{accurate}, and the width ratio that is correlated with the second reference photographing distance is defined as R_{accurate}′; calculating an accurate width W₂ of the target plate according to the pixel width w₁ and the R_{accurate}′; and calculating an accurate length L₂ of the target plate according to the pixel length l₁ and the R_{accurate};
(2.10) taking out, by the plate transferring mechanism, the target plate from the plate-carrying surface followed by placing on an appropriate shelf of the storage mechanism for storage; and correlating size information of the target plate with the appropriate shelf followed by uploading to a cloud; and
(2.11) repeating steps (2.2)-(2.10) until all plates at the receiving mechanism are respectively placed on appropriate shelves;
(3) performing outbound of the target plate through steps of:
(3.1) acquiring a required plate size; matching the required plate size with the size information stored in the cloud; and determining a corresponding shelf according to the size information; and
(3.2) taking out, by the plate transferring mechanism, a to-be-processed plate from the corresponding shelf followed by placing at the discharging mechanism; and taking out, by a worker, the to-be-processed plate from the discharging mechanism followed by sending to a next workstation for processing.

In some embodiments, the rough width W₁ is calculated through the following equation:

$${W}_{1} = {w}_{1} \times {R}_{rough}^{′} ;$$

the rough length L₁ is calculated through the following equation:

$${L}_{1} = {l}_{1} \times {R}_{rough} ;$$

the accurate width W₂ is calculated through the following equation:

$${W}_{2} = {w}_{1} \times {R}_{accurate}^{′} ;$$

and
the accurate length L₂ is calculated through the following equation:

$${L}_{2} = {l}_{1} \times {R}_{accurate} .$$

Compared to the prior art, the present disclosure has the following beneficial effects.

In the present disclosure, the coordinated use of the photographing mechanism, the plate transferring mechanism, the receiving mechanism, the storage mechanism, the discharging mechanism and the control processor can automatically complete inbound and outbound operations of the target plates. By combining with weighing and photographic measurement technology, the size of the target plate can be automatically measured, so that the target plate with desired size can be quickly selected for outbound during the subsequent deep processing of artificial stone plates.

### BRIEF DESCRIPTION OF THE DRAWINGS

FIG. 1 is a structural diagram of a plate warehousing device in accordance with an embodiment of the present disclosure;

FIG. 2 schematically shows a plate transferring mechanism in a state of placing a plate on a weighing mechanism in accordance with an embodiment of the present disclosure;

FIG. 3 schematically shows a plate transferring mechanism in a state of placing a plate on a weighing mechanism in accordance with another embodiment of the present disclosure;

FIG. 4a is a side view of the weighing mechanism in accordance with an embodiment of the present disclosure;

FIG. 4b is a side view of a photographing mechanism in accordance with an embodiment of the present disclosure;

FIG. 5 is a structural diagram of the weighing mechanism in accordance with an embodiment of the present disclosure;

FIG. 6 is a structural diagram of a storage mechanism in accordance with an embodiment of the present disclosure;

FIG. 7 is a structural diagram of a movable lifting assembly in accordance with an embodiment of the present disclosure; and

FIG. 8 schematically shows the movable lifting assembly in a state of driving a locking component to separate from a positioning component in accordance with another embodiment of the present disclosure.

In the drawings: 1. photographing mechanism; 2. plate transferring mechanism; 3. weighing mechanism; 31. base plate; 32. first supporting rod; 33. second supporting rod; 34. bracket; 35. supporting leg; 4. receiving mechanism; 5. storage mechanism; 51. shelf; 511. positioning component; 512. locking component; 5121. main portion; 5122. limiting portion; 5123. hooking portion; 52. shelf moving track; 53. movable lifting assembly; 531. traveling trolley; 532. electric linear cylinder; 54. trolley track; and 6. discharging mechanism.

### DETAILED DESCRIPTION OF EMBODIMENTS

The embodiments of the present disclosure are described in detail below, and are shown schematically in the accompanying drawings, where the same or similar reference numerals throughout represent the same or similar elements or elements with the same or similar functions. The embodiments described below with reference to the drawings are merely illustrative for explaining the present disclosure, and are not intended to limit the scope of the present disclosure.

In the description of the embodiments, it should be understood that orientation or positional relationships related to orientation descriptions, such as “longitudinal”, “lateral”, “up”, “down”, “front”, “back”, “left”, “right”, “vertical”, “horizontal”, “top”, “bottom”, “inside” and “outside”, are based on orientation or position relationships shown in the drawings, which are merely intended to facilitate the description of the embodiments and simplify the description, and are not intended to indicate or imply that a device or element referred to must have a specific orientation, be constructed and operated in a specific orientation. Therefore, these orientation or positional relationships cannot be construed as limiting the present disclosure. In addition, features defined as “first” and “second” may explicitly or implicitly include one or more such features, and are only used to distinguish technical features, without any distinction in order or importance.

In the description of the present disclosure, unless otherwise clearly specified and defined, terms such as “mount”, “communicate” and “connect” should be understood in a broad sense. For example, it can be a fixed connection, a detachable connection, or an integrated connection; it can be a mechanical connection or an electrical connection; it can be a direct connection or an indirect connection through an intermediate medium, or it can be an internal connection of two elements. For those of ordinary skill in the art, the specific meanings of the above terms in the present disclosure can be understood according to specific circumstances.

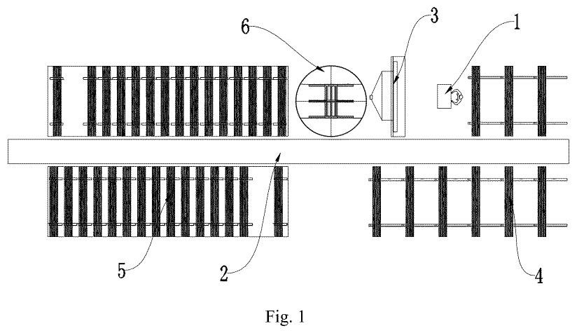

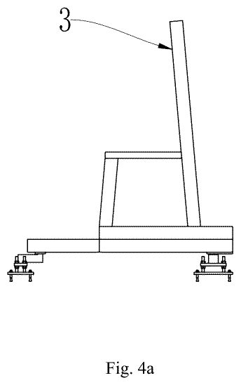

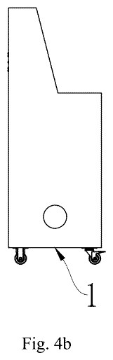

The technical solution of the present disclosure will be further described below with reference to FIGS. 1-3, 4a-b and 5-8 in conjunction with the specific embodiments.

As shown in FIGS. 1-3, 4a-b and 5-8, a plate warehousing device is provided, which includes a photographing mechanism 1, a plate transferring mechanism 2, a weighing mechanism 3, a receiving mechanism 4, a storage mechanism 5, a discharging mechanism 6 and a control processor.

The receiving mechanism 4 is configured to receive a target plate after being produced by a production line.

The plate transferring mechanism 2 is configured to transfer the target plate among the receiving mechanism 4, the storage mechanism 5, the weighing mechanism 3 and the discharging mechanism 6.

The storage mechanism 5 is configured to store the target plate after being put into a warehouse.

The weighing mechanism 3 is provided with a plate-carrying surface. The plate-carrying surface is configured to carry the target plate. The weighing mechanism is configured to acquire a weight of the target plate when the target plate is placed on the plate-carrying surface.

The photographing mechanism 1 has a photographing end facing toward the plate-carrying surface. The photographing mechanism is configured to photograph a target surface of the target plate when the target plate is placed on the weighing mechanism to obtain an image of the target surface.

The discharging mechanism 6 is configured to receive the target plate from the plate transferring mechanism 2.

The control processor is in communication connection with the photographing mechanism 1, the plate transferring mechanism 2 and the weighing mechanism 3. The control processor is configured to receive the weight and the image of the target surface, and calculate size parameters of the target plate according to the weight of the target plate and the image of the target surface.

In the present disclosure, by virtue of the cooperation of the photographing mechanism 1, the plate transferring mechanism 2, the weighing mechanism 3, the receiving mechanism 4, the storage mechanism 5, the discharging mechanism 6 and the control processor, the inbound and outbound operations of the target plate can be automatically completed, and the size of the target plate can be automatically measured by combining weighing and photographing measurement technology, so that the target plate with a desired size can be quickly selected for outbound during the subsequent deep processing of artificial stone plates.

It is worth noting that the present disclosure combines weighing and photographing measurement technology to calculate the thickness of the plate, and a reference thickness closest to the calculated thickness is selected as a rough thickness, then a photographing distance is corrected according to the rough thickness, and the size of the plate is calculated according to the corrected photographing distance. This leads to a more accurate measured plate size, and the plate size information can be automatically measured without manual labor, resulting in higher efficiency.

As shown in FIG. 1, the receiving mechanism 4 is a fixed stacking rack, and the discharging mechanism 6 is a rotary stacking rack.

Specifically, the target plate after being produced by the production line can be placed on the fixed stacking rack through a forklift. The plate transferring mechanism 2 is a suction cup-type manipulator, which can be adjusted at multiple angles, so there is no need to adjust an angle of the target plate to adapt to the plate transferring mechanism 2. The target plate with measured size is placed on the rotary stacking rack by the plate transferring mechanism 2. The angle of the target plate can be adjusted by the rotary stacking rack to facilitate a worker to take out the target plate from the warehouse by a forklift.

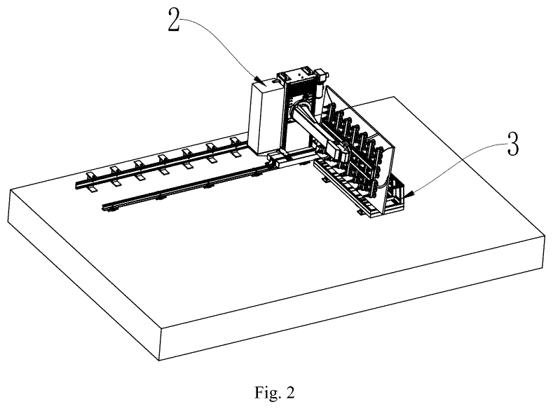

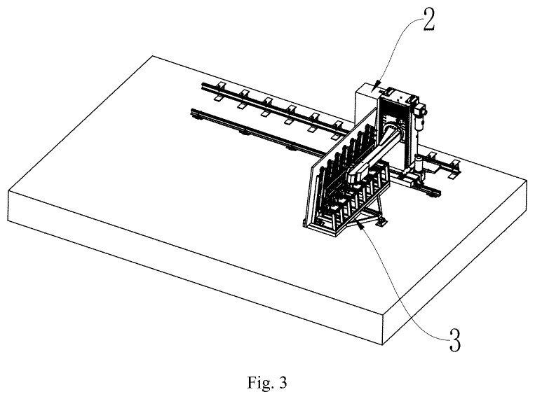

As shown in FIGS. 2-3, the plate transferring mechanism 2 is a suction cup-type manipulator having a picking end. A visual recognition mechanism is mounted at the picking end. The visual recognition mechanism is configured to identify whether a surface of the target plate sucked by the picking end is the target surface to ensure the target surface to be directly opposite to the photographing end.

Specifically, the target plate is transferred by the suction cup-type manipulator in a suction manner, which is convenient and fast.

More specifically, the target surface is a front-view surface of the target plate, which contains a pattern or color. When the target plate is taken out from the receiving mechanism 4 by the plate transferring mechanism 2, a sucked surface of the target plate at the picking end of the plate transferring mechanism 2 is identified by the visual recognition mechanism. If the sucked surface is the front-view surface, the target plate can be placed on the weighing mechanism 3 in the manner shown in FIG. 2. If the sucked surface is not the front-view surface, the target plate can be placed on the weighing mechanism 3 in the manner shown in FIG. 3. In this way, the target surface is directly opposite to the photographing end of the photographing mechanism 1.

Furthermore, after the size recognition is completed, accurate width W₂, accurate length L₂, production batch number, serial number, pattern or color of the front-view surface and other related information of the target plate are uploaded to a cloud for storage, and can be retrieved by scanning a code during the production and deep processing of plates.

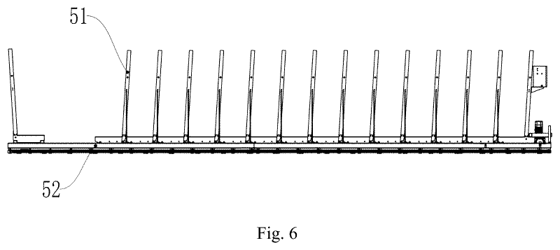

As shown in FIGS. 6-8, the storage mechanism 5 includes a plurality of shelves 51 and a shelf moving track 52.

The plurality of shelves 51 are movably arranged on the shelf moving track 52. The shelf moving track 52 is configured to guide a movement direction of the plurality of shelves 51.

Along a guiding direction of the shelf moving track 52, a first end of each of the plurality of shelves 51 is mounted with a positioning component 511, and a second end of each of the plurality of shelves 51 is mounted with a locking component 512. The locking component 512 of one of adjacent two shelves among the plurality of shelves 51 is hooked to the positioning component 511 of the other of the adjacent two shelves 51.

A movable lifting assembly 53 is provided below the plurality of shelves 51, and is movable along the shelf moving track 52. The movable lifting assembly 53 is configured to drive the locking component 512 to rotate, such that the locking component 512 is separated from a corresponding positioning component 511 hooked thereto.

Specifically, in the present disclosure, adjacent two shelves 51 can be connected together by hooking the locking component 512 with the positioning component 511, so that the plurality of shelves 51 can be transferred at the same time during transfer, thereby improving the efficiency of transferring the plurality of shelves 51. Moreover, the locking component 512 can be driven by the movable lifting assembly 53 to rotate to be separated from the positioning component 511, so that the adjacent two shelves 51 can be separated from each other for transferring a single shelf 51.

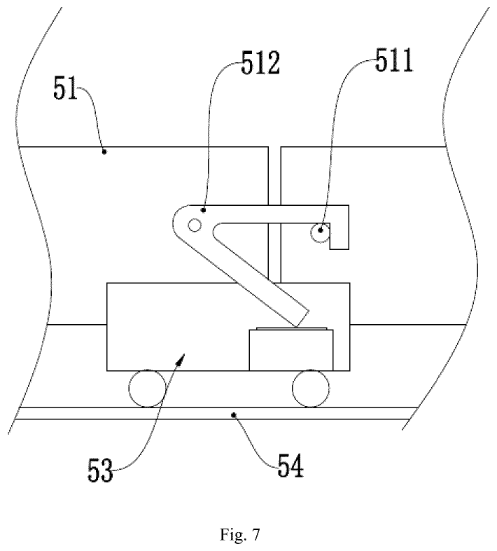

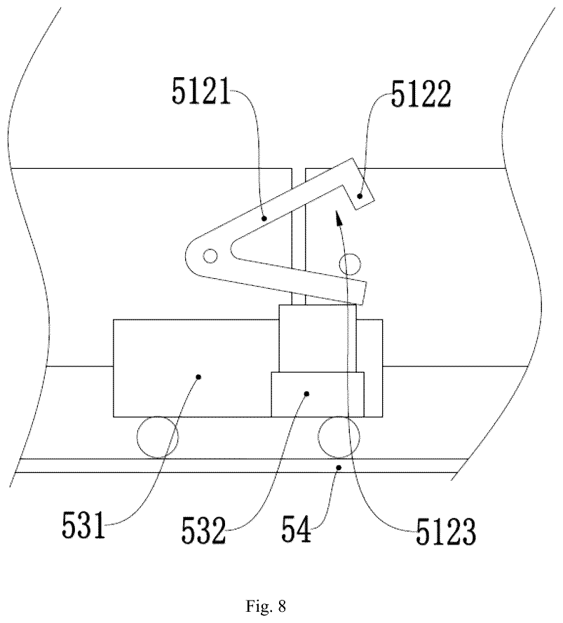

As shown in FIGS. 7-8, the locking component 512 includes a main portion 5121 and a limiting portion 5122 extending from a first end of the main portion 5121.

The positioning component 511 is mounted at a first lower end of a side wall of each of the plurality of shelves 51. The locking component 512 is mounted at a second lower end of the side wall of each of the plurality of shelves 51.

The main portion 5121 is rotatably connected to each of the plurality of shelves 51. The limiting portion 5122 is configured to be folded relative to the first end of the main portion 5121. A hooking portion 5123 is provided at a connection between the limiting portion 5122 and the main portion 5121, and is hooked to the positioning component 511.

It can be understood that the limiting portion 5122 is driven by the main portion 5121 to rotate, thereby driving the hooking portion 5123 and the limiting portion 5122 to move, so that the hooking portion 5123 hooks the positioning component 511.

It is worth noting that when performing inbound and outbound of the target plate, adjacent two shelves 51 need to be separated. When separating the adjacent two shelves 51, the movable lifting assembly 53 is driven to move to one of the adjacent two shelves 51 (hereinafter “shelf A”). The locking component 512 of the shelf A is driven by the movable lifting assembly 53 to rotate for separation from the positioning component 511 of the other of the adjacent two shelves 51 (hereinafter “shelf B”) hooked thereto. Then, the shelf B is moved to be separated from the shelf A. A gap formed after the adjacent two shelves 51 are separated allows the picking end of the plate transferring mechanism 2 to pass through. Then, the target plate can be placed on the shelf A or removed from the shelf B by the plate transferring mechanism 2, so as to complete the inbound and outbound operations of the target plate.

Specifically, when performing inbound of the target plate, the plate transferring mechanism 2 takes out the target plate from the weighing mechanism 3 and places the target plate on a shelf A after separation. Then, the shelf A is driven to move to be attached to a shelf B that is hooked to the shelf A before separation. The locking component 512 of the shelf B is driven to rotate by the movable lifting assembly 53 to be hooked to the positioning component 511 of the shelf A. When performing outbound of the target plate, the target plate is taken out from the shelf 51 and placed at the discharging mechanism 6 by the plate transferring mechanism 2.

As shown in FIGS. 7-8, the movable lifting assembly 53 includes a traveling trolley 531 and a trolley track 54. The trolley track 54 is arranged side by side with the shelf moving track 52. The traveling trolley 531 is movably arranged on the trolley track 54, and the trolley track 54 is configured to guide a movement direction of the traveling trolley 531.

The traveling trolley 531 is mounted with an electric linear cylinder 532 having a telescopic end.

Specifically, the electric linear cylinder 532 is driven to move by the traveling trolley 531, so that the telescopic end of the electric linear cylinder 532 is attached to a second end of the main portion 5121. Then, the second end of the main portion 5121 is lifted by the telescopic end, so that the main portion 5121 is driven to rotate, and the limiting portion 5122 at the first end of the main portion 5121 is gradually lifted until the limiting portion 5122 is separated from the positioning component 511. At this time, the connection between the adjacent two shelves 51 is unlocked, and the adjacent two shelves 51 can be moved separately.

It is worth noting that an end of each of the plurality of the shelves 51 is provided with a moving component. When it is necessary to take out a plate from a shelf located in the middle position among the plurality of shelves 51, the middle shelf 51 can be separated from an adjacent shelf 51. Since the shelves 51 from the middle shelf to the end shelf are still connected successively, moving the end shelf 51 by the moving component can drive the middle shelf 51 to move. As a result, a sufficient gap is left between the middle shelf 51 and the adjacent shelf, allowing the picking end of the plate transferring mechanism 2 to pass through and transfer the plates on the middle shelf 51.

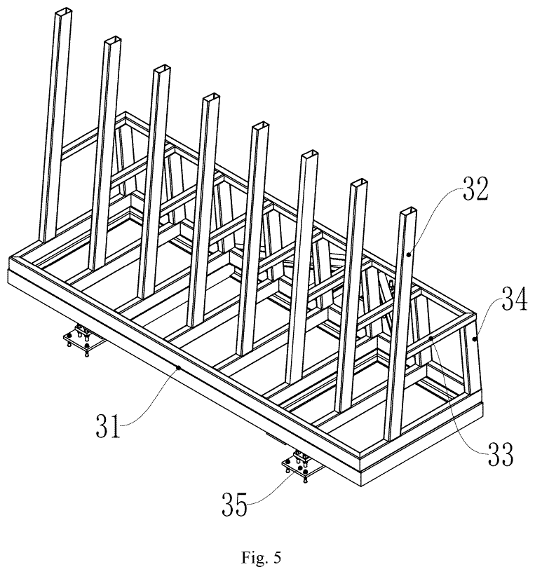

As shown in FIG. 5, the weighing mechanism 3 includes a base plate 31. A plurality of supporting legs 35 are mounted at a bottom surface of the base plate 31. A weighing sensor is provided between each of the plurality of supporting legs 35 and the base plate 31. A plurality of first supporting rods 32 are provided at a top surface of the base plate 31. The plurality of first supporting rods 32 are respectively configured to be extended obliquely and upwardly to form the plate-carrying surface arranged obliquely. A side of each of the plurality of first supporting rods 32 is provided with a supporting component. The supporting component is configured to support a middle portion of the plurality of first supporting rods 32.

Specifically, when placing the target plate on the weighing mechanism 3, the target plate is placed obliquely at the top of the base plate 31 and is attached to the plate-carrying surface formed by the plurality of first supporting rods 32, so that the target plate can be stably placed at the top of the base plate 31.

As shown in FIG. 5, the supporting component is composed of a plurality of second supporting rods 33 and a bracket 34. First ends of the plurality of second supporting rods 33 are respectively connected to the plurality of first supporting rods 32. Second ends of the plurality of second supporting rods 33 are connected to the bracket 34. A bottom end of the bracket 34 is fixedly mounted on the top surface of the base plate 31.

The plurality of first supporting rods 32 are arranged in parallel and at equal intervals. The plurality of second supporting rods 33 are arranged in parallel and at equal intervals.

Specifically, the plurality of first supporting rods 32 are supported by the plurality of second supporting rods 33 and the bracket 34, so that the plate-carrying surface have an excellent bearing capacity to adapt to different types of plates.

Furthermore, the plurality of first supporting rods 32 are arranged in parallel and at equal intervals, and the plurality of second supporting rods 33 are arranged in parallel and at equal intervals, so that there can be equal-distance gaps between adjacent first supporting rods 32 and equal-distance gaps between adjacent second supporting rods 33. This makes it easier for the picking end to pass through the gaps and place the target plate on the weighing mechanism 3.

In an embodiment, the number of the plurality of supporting legs 35 is three. The three supporting legs 35 are distributed in a triangular shape at the bottom surface of the base plate 31, so that the weighing mechanism 3 has excellent stability, and is not prone to tipping.

As shown in FIGS. 1-3, 4a-b and 5-8, an inbound and outbound method applied to the above plate warehousing device is provided, which includes the following steps.

### Step (1) Initialization Settings

(S1.1) Pixel lengths and pixel widths of n surface images of a reference plate obtained by photographing the reference plate at n reference photographing distances respectively are collected. A length ratio of a surface length of the reference plate to a pixel length of each of the n surface images of the reference plate is acquired, and a width ratio of a surface width of the reference plate to a pixel width of each of the n surface images of the reference plate is acquired, where n≥2.

(S1.2) The n reference photographing distances are correlated with a corresponding length ratio and a corresponding width ratio.

### Step (2) Target Plate Identification During Inbound

(S2.1) The target plate is placed at the receiving mechanism 4.

(S2.2) When performing inbound of the target plate, the target plate is taken out from the receiving mechanism 4 and placed on the plate-carrying surface according to recognition information of a visual recognition mechanism by the plate transferring mechanism 2, so that the target surface is directly opposite to the photographing end.

(S2.3) The weight M of the target plate is acquired through the weighing mechanism 3.

(S2.4) A mounting distance H₁ from the photographing mechanism 1 to the plate-carrying surface is acquired. The mounting distance H₁ is matched with the n reference photographing distances to determine a first reference photographing distance among the n reference photographing distances that is equal to the mounting distance H₁. A length ratio and a width ratio that are correlated with the first reference photographing distance are acquired. The length ratio that is correlated with the first reference photographing distance is defined as R_{rough}, and the width ratio that is correlated with the first reference photographing distance is defined as R_{rough}′.

(S2.5) The image of the target surface is acquired. a pixel width w₁ and a pixel length l₁ of the target surface are acquired according to the image of the target surface. A rough width W₁ of the target plate is calculated according to the pixel width w₁ and the R_{rough}′. A rough length L₁ of the target plate is calculated according to the pixel length l₁ and R_{rough}.

(S2.6) A rough thickness D₁ of the target plate is calculated as: D₁=M/(W₁×L₁×ρ), where ρ is a preset density.

(S2.7) The obtained rough thickness D₁ is compared with a plurality of preset reference thicknesses, and a preset reference thickness that is closest to the rough thickness D₁ among the plurality of preset reference thicknesses is selected as a final thickness D₂ of the target plate.

(S2.8) A photographing distance H₂ from the photographing mechanism 1 to the target surface is calculated as: H₂=H₁−D₂.

(S2.9) The photographing distance H₂ is matched with the n reference photographing distances to determine a second reference photographing distance that is equal to the photographing distance H₂ among the n reference photographing distances. A length ratio and a width ratio that are correlated with the second reference photographing distance are acquired, where the length ratio that is correlated with the second reference photographing distance is defined as R_{accurate}, and the width ratio that is correlated with the second reference photographing distance is defined as R_{accurate}′. An accurate width W₂ of the target plate is calculated according to the pixel width w and the R_{accurate}′. An accurate length L₂ of the target plate is calculated according to the pixel length l₁ and the R_{accurate}.

(S2.10) After calculating the accurate width W₂ and accurate length L₂, the target plate is taken out from the plate-carrying surface and placed on an appropriate shelf 51 by the plate transferring mechanism 2 for storage. At the same time, size information of the target plate is correlated with the appropriate shelf 51, and the correlated information is uploaded to a cloud for storage.

(S2.11) Steps (S2.2-S2.10) are repeated until all plates at the receiving mechanism 4 are respectively placed on appropriate shelves 51 for storage.

### Step (3) Outbound of the Target Plate

(S3.1) A required plate size is acquired. The required plate size is matched with the correlated information stored in the cloud. Information of the corresponding shelf 51 is acquired according to the correlated information.

(S3.2) A to-be-processed plate is taken out from the corresponding shelf 51 by the plate transferring mechanism 2 according to the information of the corresponding shelf 51, and placed at the discharging mechanism 6. Then, the to-be-processed plate is taken out from the discharging mechanism 6 and sent to a next workstation by a worker for processing.

As shown in FIGS. 1-8, in step (S2.5), the rough width W₁ is calculated as: W₁=w₁×R_{rough}′, and the rough length L₁ is calculated as: L₁=l₁×R_{rough}. In step (S2.9), the accurate width W₂ is calculated as W₂=w₁×R_{accurate}′, and the accurate length L₂ is calculated as L₂=l₁×R_{accurate}.

Specifically, the obtained rough thickness D₁ is compared with approximate preset reference thicknesses, and the preset reference thickness that is closest to the rough thickness rough thickness D is selected as the final thickness D₂. This is because the rough thickness D₁ obtained according to the rough width W, and the rough length L₁ has an error. However, the pressing and forming of artificial stone plates is carried out according to a preset thickness, so it is necessary to compare the rough thickness D₁ with approximate reference thicknesses, and select the closest standard thickness as the final thickness D₂ of the plate to reduce the calculation error. However, the actual size of a finished artificial stone plate is affected by various environmental or production factors, resulting in differences from the production requirements. Therefore, the size of the artificial stone plate needs to be measured before the plate is further processed.

Furthermore, the photographing distance H₂ is calculated based on the final thickness D₂, and can be adjusted and corrected to eliminate the error caused by the plate thickness in the size measurement of the captured image, thereby further improving the measurement accuracy.

Moreover, in order to avoid the influence of the distortion of the camera lens on the imaging effect, it is necessary to perform pre-processing such as distortion correction on the captured image after photographing, so that the pixel width and pixel length of the acquired surface image are more accurate, thereby improving the measurement accuracy of the plate size.

It is worth noting that the step (S1.1) is performed as follows.

A size of the reference plate is inputted, including a reference width W_{reference} and a reference length L_{reference}.

A surface image of the reference plate at a preset reference photographing distance is acquired. A pixel width W_{reference} and pixel length/reference of the plate surface of the reference plate is extracted from the surface image of the reference plate.

A length ratio R_{reference} and width ratio R_{reference}′ correlated with the preset reference photographing distance are respectively calculated as:

$${R}_{r e f e r e n c e} = {L}_{r e f e r e n c e} / {l}_{r e f e r e n c e} , and {R}_{reference}^{′} = {W}_{r e f e r e n c e} / {w}_{r e f e r e n c e} .$$

It can be understood that the reference plate is photographed at n reference photographing distances to obtain the n surface images of the reference plate, and the pixel widths w_{reference} and pixel lengths l_{reference} of the plate surface of the reference plate are acquired according to the n surface images of the reference plate, so that the length ratios R_{reference} and width ratios R_{reference}′ respectively correlated with the n reference photographing distances are calculated.

The above embodiments serve to explain the principles of the present disclosure, and are not intended to limit the scope of the present application. Based on the embodiments in the present disclosure, all other embodiments obtained by those of ordinary skill in the art without making creative efforts shall fall within the scope of the present disclosure.

What is claimed is:

1. A plate warehousing device, comprising:
a photographing mechanism;
a plate transferring mechanism;
a weighing mechanism;
a receiving mechanism;
a storage mechanism;
a discharging mechanism; and
a control processor;
wherein the receiving mechanism is configured to receive a target plate after being produced by a production line;
the plate transferring mechanism is configured to transfer the target plate among the receiving mechanism, the storage mechanism, the weighing mechanism and the discharging mechanism;
the storage mechanism is configured to store the target plate after being put into a warehouse;
the weighing mechanism is provided with a plate-carrying surface; the plate-carrying surface is configured to carry the target plate; and the weighing mechanism is configured to acquire a weight of the target plate when the target plate is placed on the plate-carrying surface;
the photographing mechanism has a photographing end facing toward the plate-carrying surface; and the photographing mechanism is configured to photograph a target surface of the target plate when the target plate is placed on the weighing mechanism to obtain an image of the target surface;
the discharging mechanism is configured to receive the target plate from the plate transferring mechanism; and
the control processor is in communication connection with the photographing mechanism, the plate transferring mechanism and the weighing mechanism; and the control processor is configured to receive the weight of the target plate and the image of the target surface, and calculate size parameters of the target plate according to the weight of the target plate and the image of the target surface.

2. The plate warehousing device of claim 1, wherein the receiving mechanism is a fixed stacking rack; and the discharging mechanism is a rotary stacking rack.

3. The plate warehousing device of claim 1, wherein the plate transferring mechanism is a suction cup-type manipulator having a picking end; a visual recognition mechanism is mounted at the picking end; and the visual recognition mechanism is configured to identify whether a surface of the target plate sucked by the picking end is the target surface to ensure the target surface to be directly opposite to the photographing end.

4. The plate warehousing device of claim 1, wherein the storage mechanism comprises a plurality of shelves and a shelf moving track;
the plurality of shelves are movably arranged on the shelf moving track; and the shelf moving track is configured to guide a movement direction of the plurality of shelves;
along a guiding direction of the shelf moving track, a first end of each of the plurality of shelves is mounted with a positioning component, and a second end of each of the plurality of shelves is mounted with a locking component; and the locking component of one of adjacent two shelves among the plurality of shelves is hooked to the positioning component of the other of the adjacent two shelves; and
a movable lifting assembly is provided below the plurality of shelves, and is movable along the shelf moving track; the movable lifting assembly is configured to drive the locking component to rotate, such that the locking component is separated from a corresponding positioning component hooked thereto.

5. The plate warehousing device of claim 4, wherein the locking component comprises a main portion and a limiting portion extending from an end of the main portion;
the positioning component is mounted at a first lower end of a side wall of each of the plurality of shelves; and the locking component is mounted at a second lower end of the side wall of each of the plurality of shelves; and
the main portion is rotatably connected to each of the plurality of shelves; the limiting portion is configured to be folded relative to the end of the main portion; and a hooking portion is provided at a connection between the limiting portion and the main portion, and is hooked to the positioning component.

6. The plate warehousing device of claim 4, wherein the movable lifting assembly comprises a traveling trolley and a trolley track; the trolley track is arranged side by side with the shelf moving track; the traveling trolley is movably arranged on the trolley track; and the trolley track is configured to guide a movement direction of the traveling trolley; and
the traveling trolley is provided with an electric linear cylinder.

7. The plate warehousing device of claim 1, wherein the weighing mechanism comprises a base plate; a plurality of supporting legs are mounted at a bottom surface of the base plate, a weighing sensor is provided between each of the plurality of supporting legs and the base plate; a plurality of first supporting rods are provided at a top surface of the base plate; the plurality of first supporting rods are configured to be extended obliquely and upwardly to form the plate-carrying surface arranged obliquely; a side of each of the plurality of first supporting rods is provided with a supporting component; and the supporting component is configured to support a middle portion of the plurality of first supporting rods.

8. The plate warehousing device of claim 7, wherein the supporting component is composed of a plurality of second supporting rods and a bracket; first ends of the plurality of second supporting rods are respectively connected to the plurality of first supporting rods; second ends of the plurality of second supporting rods are connected to the bracket; and a bottom end of the bracket is fixedly mounted on the top surface of the base plate; and
the plurality of first supporting rods are arranged in parallel and at equal intervals, and the plurality of second supporting rods are arranged in parallel and at equal intervals.

9. An inbound and outbound method applied to the plate warehousing device of claim 1, comprising:
(1) performing initialization settings through steps of:
(1.1) collecting pixel lengths and pixel widths of n surface images of a reference plate obtained by photographing the reference plate at n reference photographing distances respectively, acquiring a length ratio of a surface length of the reference plate to a pixel length of each of the n surface images of the reference plate, and acquiring a width ratio of a surface width of the reference plate to a pixel width of each of the n surface images of the reference plate, wherein n≥2; and
(1.2) correlating the n reference photographing distances with a corresponding length ratio and a corresponding width ratio;
(2) identifying the target plate during inbound through steps of:
(2.1) placing the target plate at the receiving mechanism;
(2.2) taking out, by the plate transferring mechanism, the target plate from the receiving mechanism followed by placing on the plate-carrying surface according to recognition information of a visual recognition mechanism, so that the target surface is directly opposite to the photographing end;
(2.3) acquiring the weight M of the target plate through the weighing mechanism;
(2.4) acquiring a mounting distance H₁ from the photographing mechanism to the plate-carrying surface; matching the mounting distance H₁ with the n reference photographing distances to determine a first reference photographing distance that is equal to the mounting distance H₁ among the n reference photographing distances; and acquiring a length ratio and a width ratio that are correlated with the first reference photographing distance, wherein the length ratio that is correlated with the first reference photographing distance is defined as R_{rough}, and the width ratio that is correlated with the first reference photographing distance is defined as R_{rough}′;
(2.5) acquiring the image of the target surface; acquiring a pixel width w₁ and a pixel length l₁ of the target surface according to the image of the target surface; calculating a rough width W₁ of the target plate according to the pixel width w₁ and the R_{rough}′; and calculating a rough length L₁ of the target plate according to the pixel length l₁ and the R_{rough};
(2.6) calculating a rough thickness D₁ of the target plate, expressed as:
$${D}_{1} = M / ( {W}_{1} \times {L}_{1} \times ρ ) ,$$
wherein ρ is a preset density;
(2.7) comparing the rough thickness D₁ with a plurality of preset reference thicknesses, and selecting a preset reference thickness that is closest to the rough thickness D₁ among the plurality of preset reference thicknesses as a final thickness D₂ of the target plate;
(2.8) calculating a photographing distance H₂ from the photographing mechanism to the target surface, expressed as:
$${H}_{2} = {H}_{1} - {D}_{2} ;$$
(2.9) matching the photographing distance H₂ with the n reference photographing distances to determine a second reference photographing distance that is equal to the photographing distance H₂ among the n reference photographing distances; acquiring a length ratio and a width ratio that are correlated with the second reference photographing distance, wherein the length ratio that is correlated with the second reference photographing distance is defined as R_{accurate}, and the width ratio that is correlated with the second reference photographing distance is defined as R_{accurate}′; calculating an accurate width W₂ of the target plate according to the pixel width w₁ and the R_{accurate}′; and calculating an accurate length L₂ of the target plate according to the pixel length l₁ and the R_{accurate};
(2.10) taking out, by the plate transferring mechanism, the target plate from the plate-carrying surface followed by placing on an appropriate shelf of the storage mechanism for storage; and correlating size information of the target plate with the appropriate shelf followed by uploading to a cloud; and
(2.11) repeating steps (2.2)-(2.10) until all plates at the receiving mechanism are respectively placed on appropriate shelves;
(3) performing outbound of the target plate through steps of:
(3.1) acquiring a required plate size; matching the required plate size with the size information stored in the cloud; and determining a corresponding shelf according to the size information; and
(3.2) taking out, by the plate transferring mechanism, a to-be-processed plate from the corresponding shelf followed by placing at the discharging mechanism; and taking out, by a worker, the to-be-processed plate from the discharging mechanism followed by sending to a next workstation for processing.

10. The inbound and outbound method of claim 9, wherein the rough width W₁ is calculated through the following equation:
$${W}_{1} = {w}_{1} \times {R}_{rough}^{′} ;$$
the rough length L₁ is calculated through the following equation:
$${L}_{1} = {l}_{1} \times {R}_{rough} ;$$
the accurate width W₂ is calculated through the following equation:
$${W}_{1} = {w}_{1} \times {R}_{accurate}^{′} ;$$
and
the accurate length L₂ is calculated through the following equation:
$${L}_{2} = {l}_{1} \times {R}_{accurate} .$$
